(19) United States
(12) Patent Application Publication
(10) Pub. No.: US 2018/0165108 A1
(43) Pub. Date: Jun. 14, 2018

(54) System and Methods for Utilizing a Script to Instruct a Bluetooth Low Energy Client in Interfacing with a Bluetooth Low Energy Server

(71) Applicant: LATTICE HEALTH SYSTEMS, INC., Austin, TX (US)

(72) Inventors: RAJU VISWAMBHARAN, MORGAN HILL, CA (US); PRAMOD MADABHUSHI, AUSTIN, TX (US); DALE TONOGAI, LOS ALTOS, CA (US)

(21) Appl. No.: 15/837,254

(22) Filed: Dec. 11, 2017

Related U.S. Application Data
(60) Provisional application No. 62/433,880, filed on Dec. 14, 2016.

(51) Int. Cl. G06F 9/455; H04L 29/06; H04L 29/08

(52) U.S. Cl. CPC G06F 9/45512; G06F 8/60; H04L 67/34; H04L 67/42

(57) ABSTRACT

A script provides instructions for a Bluetooth LE client to interface with a Bluetooth LE server. Such scripts may be created manually or may be generated by a Bluetooth LE client reading the GATT profile of a Bluetooth LE server, in which case actions are generated based upon the permission the client has with respect to each characteristic. In some cases the generated scripts may require additional instructions before they are deployed. A service provides interfaces to accept scripts, check the scripts for errors, and generates alerts for errors or when additional instructions are required. When the service determines that scripts are ready for use by Bluetooth LE clients the service distributes them to said clients.

### CROSS-REFERENCE TO RELATED APPLICATION

This application claims the benefit of U.S. Patent Application No. 62/433,880, filed Dec. 14, 2016, and entitled SYSTEM AND METHODS FOR UTILIZING A SCRIOPT TO INSTRUCT A BLUETOOTH LOW ENERGY CLIENT IN INTERFACING WITH A BLUETOOTH LOW ENERGY SERVER, which is incorporated herein by reference in its entirety.

### TECHNICAL FIELD

Systems and methods are provided for utilizing scripts with instructions for Bluetooth LE clients interfacing with Bluetooth LE servers.

### BACKGROUND

Increasing numbers of smart devices are being deployed to provide measurement data to other devices or systems that utilize this data. The interworking of such devices in this manner is sometimes referred to as the “Internet of Things (IoT)”. Such devices are often independently designed and developed by many different parties. There is a continuous desire for methods that ease the deployment and integration of these devices into a variety of systems and services to take advantage of their many capabilities.

### SUMMARY

One example method is provided for a Bluetooth LE client to use a script to control how it interfaces with a Bluetooth LE Server. The client reads a script comprised of instructions for interfacing with devices of a particular class. In response to detecting a server advertisement the client utilizes the server advertisement to make a determination as to whether the script should be executed. If said determination is made then the client executes the script.

Another example method is provided for a Bluetooth LE client to create a script comprised of instructions for interfacing with a Bluetooth LE server. The client reads the profile of a Bluetooth LE server. The profile is comprised of one or more services and the said services are comprised of one or more characteristics. The client reads the permissions available for each characteristic and generates an action step in the script based upon the permissions.

Yet another example method is provided for a service to validate and distribute a script comprised of instructions for a Bluetooth LE client to interface with a Bluetooth LE server. The service receives the script and checks it for alterable conditions. In response to detecting such conditions alerts are generated. The service also checks the script to determine if it is ready to be distributed to a Bluetooth LE client. If the script is ready, the service distributes the script to one or more Bluetooth LE clients.

### BRIEF DESCRIPTION OF THE DRAWINGS

FIG. 1 illustrates a logical representation of a GATT server profile.

FIG. 2 shows a simplified schematic of a system embodying the present invention.

FIG. 3 is a flowchart illustrating an example method of a client utilizing the scripts of this disclosure to manage its interactions with server devices.

FIG. 4 is a flowchart illustrating an example method of a client executing a script of the present invention.

FIG. 5 is a flowchart illustrating an example method of a client reading the GATT structure of a Bluetooth LE server device to generate a script.

FIG. 6 is a flowchart illustrating an example method for a system validating and distributing a new script.

### DETAILED DESCRIPTION

This disclosure relates to the use of a script to provide instructions to a Bluetooth Low Energy client device for connecting to and collecting data from a Bluetooth LE server device. Prior to describing the script and other components of the invention disclosed herein, it will be helpful to provide background information about Bluetooth LE.

Bluetooth LE is a client-server protocol, with one of the client or server devices acting as a master and the other in a slave role. Master (or “central”) devices scan for other devices. Typically the master device is a smartphone, tablet, personal computer or a specialized device, such as a controller. Slave (or “peripheral”) devices advertise and wait for connections. Usually the slave is a small device such as, for example, a fitness tracker or smart-watch, or it might be a personal health device such as a blood-pressure monitor or a weight-scale. A device can switch between being a master or slave, but it cannot be both at the same time. Client devices access remote resources over a Bluetooth LE link using a protocol called the Attribute (ATT) protocol. There is a higher level protocol called the General Attribute (GATT) protocol, built on top of the core ATT protocol, which Bluetooth LE devices use to communicate with one another. Server devices are comprised of a local database and access control methods as defined by the GATT protocol, and provide resources to remote clients. A device can concurrently be both a server and a client.

ATT defines the core data structure used in Bluetooth LE and the operations used to access this data structure. Bluetooth LE data is comprised of attributes, which are always located on the server and accessed by the client. Clients may also sometimes modify attributes. Each attribute is comprised of four fields: 1) Handle—a serial index of two octets; 2) Type—a 128 bit UUID describing the kind of data present in the Value field of the attribute; 3) Permissions—meta data describing what ATT operations can be performed on the attribute; and 4) Value—the actual data content of the attribute. There are four operations that can be performed on an attribute to move data between the client and server: read and write operations are requested by the client and the server responds (or acknowledges); notify and indicate operations are enabled by the client, but initiated by the server, providing a way to push data to the client.

GATT is built on top of ATT and provides a way to specify a hierarchical structure of higher level objects understood by the client and server. Each object is specified as a grouping of attributes. Every Bluetooth LE device is comprised of three different types of objects: 1) Profile—each Bluetooth LE device has one or more Profiles defined, where each Profile describes a collection of features. The Bluetooth Special Interest Group (SIG) describes a set of standard profiles—for example, Heart Rate, Blood Pressure, Health Thermometer and many others; 2) Service—each profile is comprised of one or more services, the service describing one feature among those included in the Profile—for example, for lighting equipment measurement of electricity usage, detection of lucidity, and control of lucidity are implemented as three independent services; and 3) characteristic—each service is comprised of one or more characteristics, where the characteristic is the actual container for data—for example, the systolic and diastolic values for a blood pressure measurement service are held inside a characteristic.

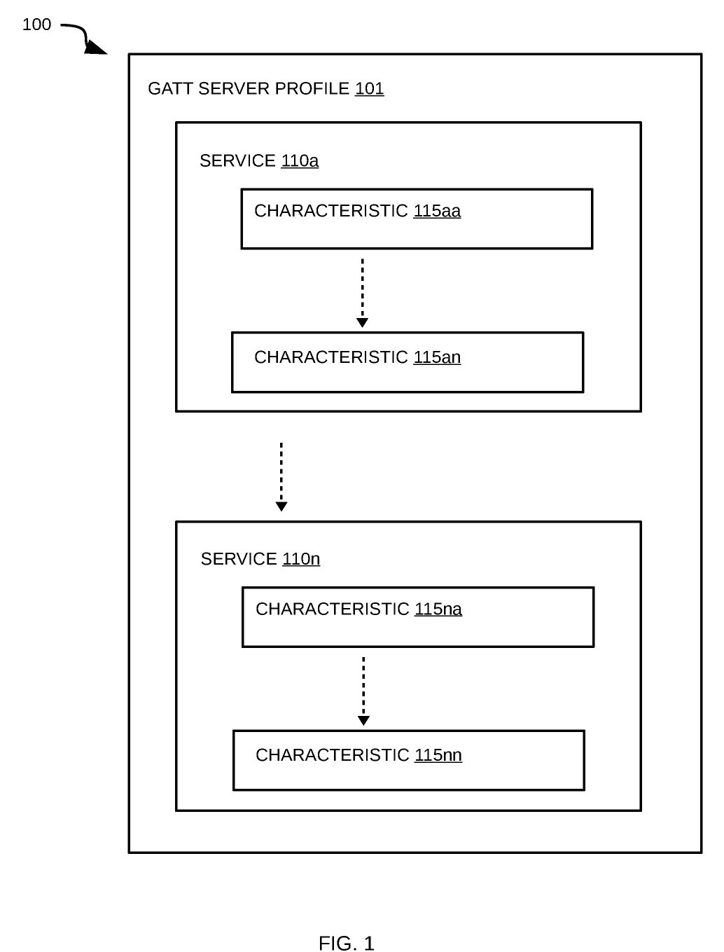

FIG. 1 illustrates a logical representation of GATT server profile 101. The profile has one or more services 110 and each service has one or more characteristics 115.

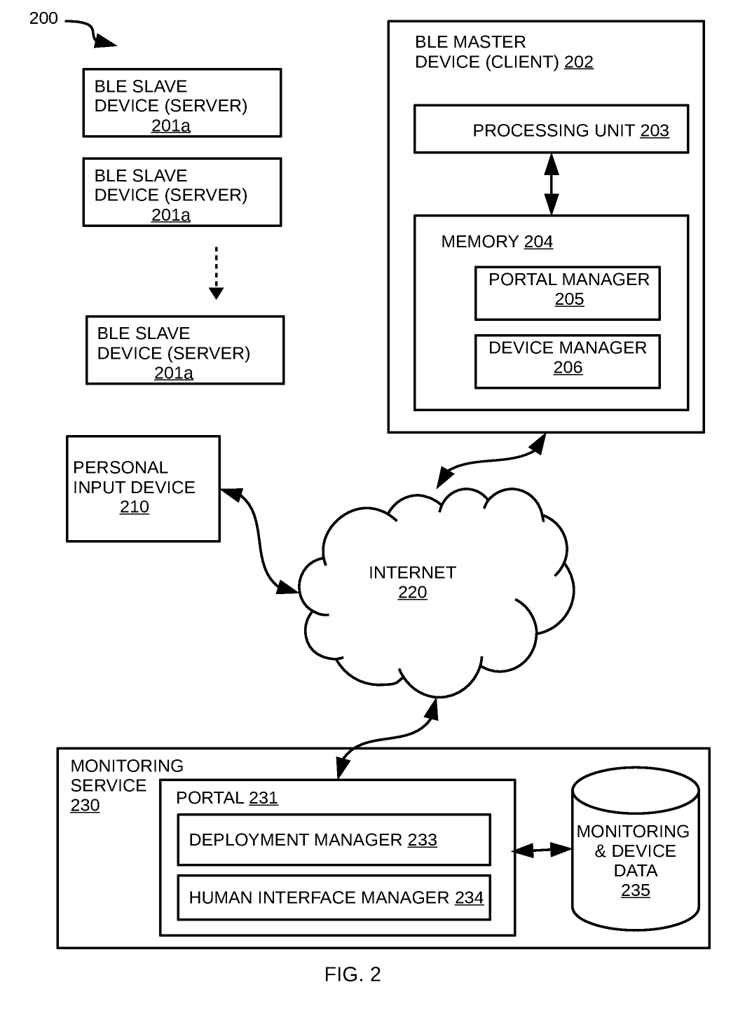

We now turn to FIG. 2, which is a simplified diagram of an example system 200 in which some of the embodiments described herein may be implemented. The system is provided as an example and is not intended to limit the various embodiments described. System 200 includes monitoring service 230, which is a cloud based service that utilizes remotely deployed Bluetooth LE devices to collect data for analysis and presentation by the monitoring service. Sensor data is received from a multitude of devices and trackers. The system is comprised of Bluetooth LE slave devices 201 (such as 201a, 201b through 201n), which take measurements and/or perform tracking functions. In a health monitoring embodiment of system 200 such slave devices 201 may, for example, include fitness trackers, blood pressure monitors, glucose monitors, weight scales, and other devices. BLE master device 202 is a device in the BLE master role described earlier. Although only one BLE master device 202 is shown, there will typically be many such devices in system 200. Such devices may be deployed at each location that is served by system 200 and/or they may be carried by individuals being monitored by system 200. As noted earlier, typically the BLE master device is also the client and the BLE slave device the server—in this example they are taking on those roles, as we have indicated on the labels of FIG. 2.

We turn now to monitoring service 230 of FIG. 2, which is a cloud based monitoring service that utilizes BLE devices to provide a monitoring service. Some components of the monitoring service related to this disclosure are illustrated, including portal 231, which provides interfaces to the service. Portal 231 includes deployment manager 233, which interfaces to devices, such as remotely installed BLE master device 202. For example, in a patient monitoring service BLE master devices 202 may be deployed at patients' residencies or carried by patents. Deployment manager 233 collects data from BLE master devices 202 for analysis and reporting. Illustrating this with a patient monitoring service, the data may be provided to the patients themselves or others (such as their health care provider or caregiver). In addition to collecting data from BLE master device 202, as will be described further in the methods outlined in this disclosure, deployment manager 233 manages BLE slave devices 201, BLE master devices 202, and their connectivity. Monitoring and device data 235 is comprised of both data needed for managing devices of the system and for data collected from such devices.

Portal 231 also includes human interface manager 234, which provides interfaces for the configuration and management of the system and its components, as well as interfaces for the presentation of monitoring data and reports. For example, human interface manager 234 may provide interfaces to provide configuration information, such as parameters for connecting devices to monitoring service 230. Interfaces may also be provided to configure and manage interfaces between BLE slave devices 201 and BLE master devices 202.

FIG. 2 also shows personal input device 210, which is a device used by an authorized user to provide information to portal 231 for configuration and management of the system. This will be further described with respect to the methods later outlined in this disclosure. Personal input device 210 is any device on which a user can provide web or other forms of input, including, for example, a laptop computer, desktop computer, tablet computer, a smartphone and other devices.

BLE master device 202 includes a number of modules such as portal manager 205 and device manager 206 that are stored in memory 204 and executed by a processing unit 203 that is coupled to the memory for accessing data and executed instructions stored therein. The memory 204 can include an arrangement of system memory and additional memory devices, such as a hard disc drive, removable storage media, read-only memory (ROM) and random access memory (RAM).

Portal manager 205 connects BLE master device 202 to portal 231. It is responsive to commands received from portal 231 and relays data to portal 231. Additionally, portal manager 205 sends alerts to portal 231 for certain conditions of BLE master device 202.

Device manager 206 interfaces with any number of local devices, such as BLE slave devices 201a to 201n. The device manager receives, for example, data from the devices and, after doing any local processing, provides it to portal manager 205 for delivery to portal 231.

BLE slave devices 201, BLE master devices 202 and the monitoring service 230 typically include familiar software and hardware components, only some of which have been illustrated. For example, they may include operating systems, processors, local memory for storage, I/O devices, and system buses interconnecting the hardware components. RAM and disk drives are examples of local memory for storage of data and computer programs. Other types of local memory include magnetic storage media, optical storage media, flash memory, networked storage devices, and the like. Monitoring service 230, including portal 231, may be comprised of multiple servers and databases.

It's desirable to have a mechanism by which interactions between BLE devices can be programmed and customized without requiring software updates. A device script is now described which can be supported by systems such as system 200 described above. The script is structured in JSON format, with each section being an array of actions: 1) an optional preamble section; 2) a required main section; and 3) one or more optional custom sections. The high level structure of the script is illustrated in Table 1, which shows all three sections, although only the main section is required:

TABLE 1

{
“preamble”:[<array of actions>],
“main”:[<array of actions>],
<custom>:[<array of actions>]
}

The preamble of the script contains commands that are only run once, when a client first connects to a device. Examples of commands that might be placed in the preamble section include setting the current time on the device or reading static information such as a model number, firmware version and the like. The main section of the script runs repeatedly and contains commands used to get measurement data from a device. Optional custom sections are named so that they can be referenced from commands in the preamble or main sections.

Each section of the script is an array of actions, with each entry in the array a set of name-value pairs representing the characteristic of interest, the operation needed on the characteristic, the value (for commands such as write) and other meta data pertaining to the command. Table 2 illustrates an array of actions. In this example each entry in the array has a command name-value pair that identifies an operation to be performed, a uuid name-value pair identifying the characteristic that the operation is to be performed against, and also an id name-value pair that may be used for purposes such as referencing an entry from other parts of the script, identifying an entry when reporting errors and for other purposes. The second entry in the array of actions includes a value for use when executing the write command.

TABLE 2

[
{
“command”: “read-value”,
“uuid”: “7274782e-6a69-7561-6e2e-425753563031”,
“id”: “step1”
},
{
“command”: “write-value”,
“uuid”: “00002a02-0000-1000-8000-00805f9b34fb”,
“value”: “020A1E”,
“id”: “step2”
},
{
“command”: “register-notify”,
“uuid”: “00002902-0000-1000-8000-00805f9b34fb”
“id”: “step3”
},
]

Table 3 lists example commands that may be used in a script and also includes notes about the commands. The commands included in Table 3 are not meant to be an exhaustive list. They are examples of commands that might be processed by a BLE client device to interface with a BLE server device.

```
TABLE 3
Discovery
    only applies to the preamble section
    does a device discovery of all services and characteristics.
Read (available as “Read-value, Read-long-value and Read-multiple)
    does a read of a characteristic or, in the case of Read-multiple,
several characteristics
Write (available as “Write-value”, “Write-long-value”, “Write-prepare”
and “Write-execute”):
    write data to a characteristic
Register (in the form of “Register-notify” and “Register-notify-group”
    provides mechanism to specify the characteristic(s) that
notify/indicate is requested for.
    takes in either the uuid or handle of the characteristic we wish to be
notified or indicated of. In the case of the group version, it takes an array
of uuids or handles to identify the characteristics of interest.
    also has an optional “type” with values of “control”, “custom” or
“measurement.” Only “measurement values are sent to the portal. If no
type is specified, then it is assumed that “measurement” is to be used.
    this command is asynchronous - that is, when the script executes this
step, it fires up a worker thread to wait on the notifications/indications
from the device while the rest of the scripting continues, which also means
that there can be other commands after this command and they will be
executed in sequence afterwards.
    Register-notify-group is the same same as register-notify, but
applies to a group of characteristics rather than a single one
    the group of charac is specified by an array called “uuid-array”
    example: “uuid-array”: [“CD02”, “CD03”, “CD04”]
    each fires up a separate worker thread to wait on
notifications/indications
    the final result is computed by combining all the results of the charcs,
in the order 1, 2, 3 ..
    if the first charc repeats - we assume a new reading is got, and send
the previously combined results even if not all charac results are received
Unregister-notify
    provides mechanism to remove a request for notification/indications
Wait-notify
    provides a mechanism to wait for a notification/indication
    optionally accepts a timeout parameter indicating how long to wait
for the notification/indication before timing out.
Sleep-ms
    provides a mechanism for a script thread to sleep for the specified
number of milliseconds
Get-security-level and set-security-level
    allows for the security level of a characteristic to be read and also set.
```

Table 4 describes parameters used with the above commands. Note that a handle or uuid parameter is required to identify the characteristic that the command is for. For some commands an array form may be used by specifying handle-array or uuid-array. This identifies a set so that the command can be applied to multiple characteristics.

```
TABLE 4
“handle”: [<string representing Handle value of the charac interested in>]
    example: “handle”: “0x000A”
“uuid”: [<uuid string of the charac interested in>]
    example: “uuid”: “00002a00-0000-1000-8000-00805f9b34fb”
“handle-array”: [<array representing a set of Handle value strings of the charac
interested in>]
    used only for “Read-multiple and “register-notify-group” commands
    example: “handle-array”: [0x000A”, “0x000B”, “0x000C”]
“uuid-array”: [<array representing a set of uuid strings of the characs interested
in> ]
    used only for “read-multiple” and “register-notify-group” commands
    example: “uuid”: [“00002a00-0000-1000-8000-00805f9b34fb”,
    “0000a350-0000-1000-8000-00805f9b34fb”
  “value”: [<value of the data to write>]
    only required for non “read” operations
    value is specified in bytes in hex string(e.g “020A1E”, indicating three
bytes of hex values 02 0A and 1E)
    length is implicit, but there is also a length field (see below) that can be
used.
    example: “value”: “020A1E”
    this field is also used for the “sleep-ms” command to specify the
integral value in milliSecs to sleep
    example: “value”: 3500
  “length”: [<int length of bytes to write>]
10  example: “length”: 3
“without-response”: “true” or “false”
    optional, used with write-value and write-long-value commands to
signify if a response is not required for write
    defaults to “false”
    example: “without-response”: “true”
“signed-write” : “true” or “false”
    optional, used with write-value and write-long-value commands to
specify if the write will be signed with a signature
    defaults to “false”
    example: “signed-write”: “true”
“repeat”: [<int value indicating the number of times to repeat the operation in this
step>]
“id”: [<string id for this step>]
    this is optional
    allows steps to be labeled, which can then be used, for example, for
conditional execution
“type”: [<one of “measurement”, “control”, “custom”>]
    used for read-value and register-notify and custom action commands
    if specified, anything other than a “measurement” type will be
considered control reading from the device and data collected from the slave
device and will not be sent to the portal
    this is optional and, for example, is used for conditional execution
support
“standard-gatt-type”: [<one of “date-time” or for other values, as needed>]
    typically used for write-value to write standard gatt defined values
    for example: “standard-gatt-type”: “date-time” signifies that we
should write current date time as defined by the GATT standard charac of
0x2A08.
    example usage:
      “command”: “write-value”,
      “standard-gatt-type”: “date-time”
      (Typically, no value needs to be given because it is implied from the
standard gatt data type).
“custom-action”:[<name of custom action>]
    option for both notify-register and notify-register-group
    notify (or group-notify) chaac spawns a thread as usual, but the script
thread control shifts from the “main” block to the “custom” block and we can
synchronize the notify data with the custom action blocks
    the custom action block can contain any commands that the Main or
Preamble can contain, and additionally can contain the “wait-notify” command -
this takes an optional “timeout-secs” indicating the time to wait for notify data to
be posted. This call returns when either the notify data arrives on the main thread,
or if the timeout expires.
```

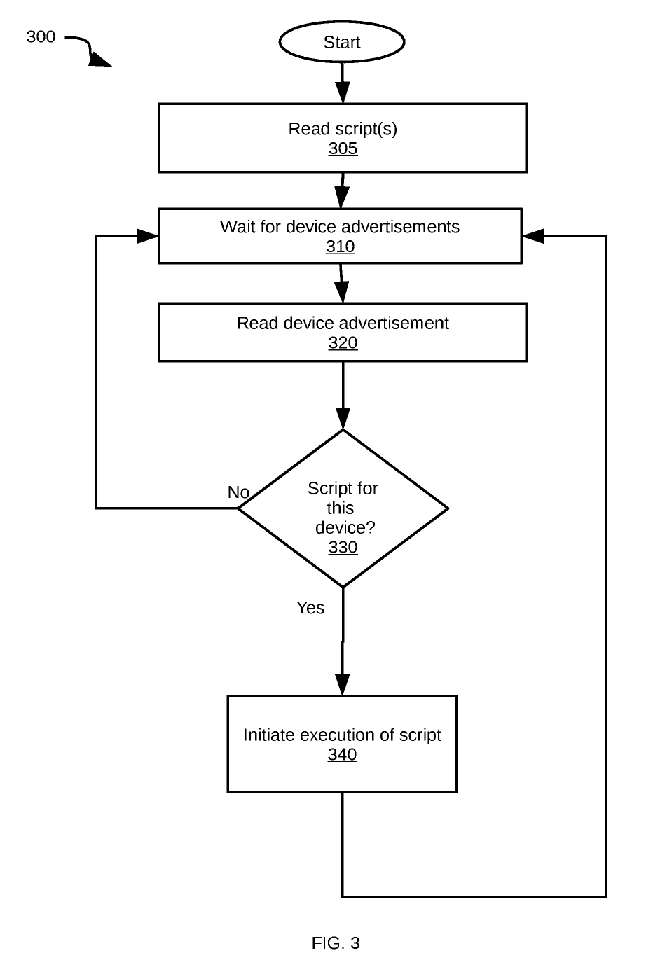

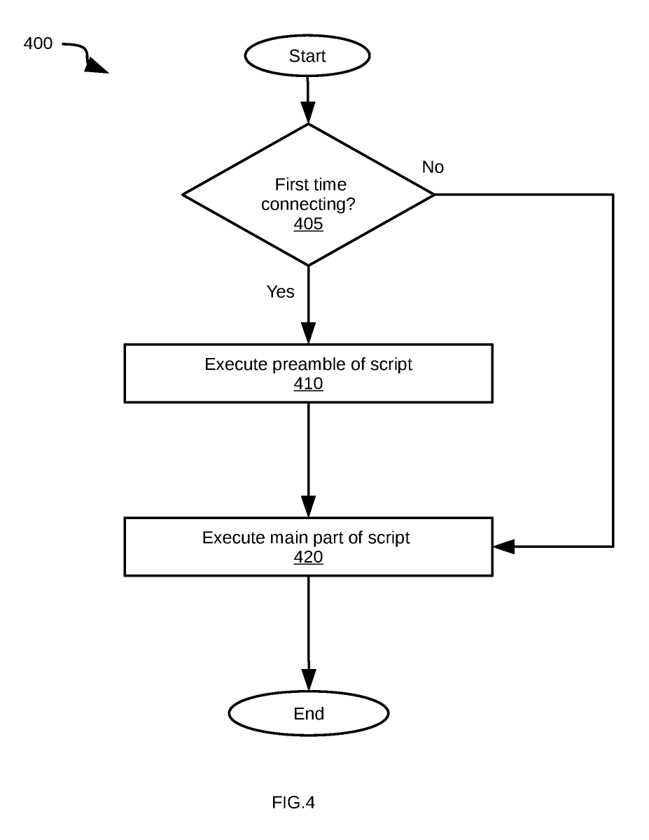

We turn now to FIG. 3, with flowchart 300 illustrating a client utilizing the scripts of this disclosure to manage its interactions with server devices. The method starts at 305 where the client reads scripts. Scripts may be read when the client initially comes up and they may also be read as new scripts are received or updates are made to existing scripts. For example, in system 200 of FIG. 2, deployment manager 233 may send scripts to clients such as 202. The client may cache partial or complete information from the scripts in its internal data structures. Continuing at 310 the client listens for advertisements from Bluetooth LE server devices. At 320, the client reads the advertisement and continues to 330 to determine if there is a script that should be run. The client may be configured to run a particular script or scripts based upon information from the advertisement, such as service type UUIDs, device info strings and the like. If there is a script for the device the method continues at 340 and initiates execution of the script, which will be discussed with reference to FIG. 4. After the script is executed the method returns to 310 to wait for device advertisements. If there is not a script for the device the method returns to 310 to wait for another device advertisement.

Having determined that a script should be executed we turn to flowchart 400 of FIG. 4, which illustrates the execution of the script by the client. Table 5 illustrates an example script, with both a preamble and a main section.

```
TABLE 5
{
  “preamble”: [
              {
                “command”: “discovery””
              }
            ],
  “main”: [
              {
              “command”: “read-value”,
                “uuid”: “00002a25-0000-1000-8000-00805f9b34fb”,
                “id”: “step1”
              },
              {
              “command”: “register-notify”,
              “uuid”: “00002902-0000-1000-8000-00805f9b34fb”
              “id”: “step2”
              },
              {
              “command”: “read-value”,
              “uuid”: “7274782e-6a69-7561-6e2e-425753563031”,
              “id”: “step3”
              },
              {
              “command”: “write-value”,
              “uuid”: “00002a02-0000-1000-8000-00805f9b34fb”,
              “value”: “020A1E”,
              “id”: “step4”
              },
              {
              “command”: “read-value”,
              “uuid”: “00002a02-0000-1000-8000-00805f9b34fb”,
              “id”: “step5”
              }
            ]
}
```

At 405 the client checks whether this is the first time that it has connected to the device. If so it continues to 410 and executes the preamble portion of the script, after which it continues at 420. In the example script of Table 5 the discovery command of the preamble section would be executed. 420 is also reached immediately when this is not the first time the client has connected to the device. In either case, once at 420 the client executes the main portion of the script. In the example script of Table 5 the five steps in the main portion of the script would be executed.

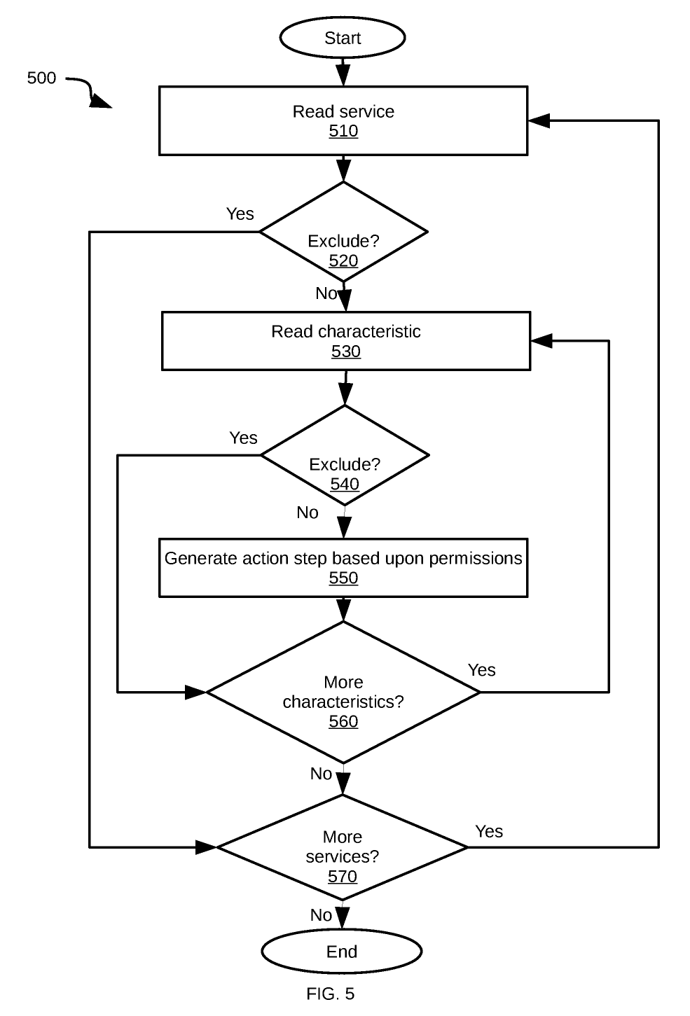

We turn now to FIG. 5, with flowchart 500 illustrating an example method of a client reading the GATT structure of a Bluetooth LE server device to generate a script. This is accomplished by reading characteristics to generate action steps for each characteristic. This method allows device manufacturers to have their devices deployed, for example, into system 200 of FIG. 2, without the need for the manufacturer to write software to interface with a controller such as client 202. Without method 500 the manufacturer may, for example, need to write device software or provide a mobile application to interface with client 202. Starting at 510 the client reads a service from the GATT structure. The client may be optionally configured to exclude certain services from the generated scripts, so at 520 the method checks to see if it has been configured to exclude the service. If the service is to be excluded the method advances to 570 to check for more services. If not, then the method continues at 530 by reading a characteristic of the service from the GATT structure. As was the case for services, the client may also be configured to exclude characteristics from generated scripts. Therefore at 540 the client checks to see if the characteristic should be excluded. If it is to be excluded, the method continues at 560 by processing other characteristics. If not, the method continues at 550 to generate an action script.

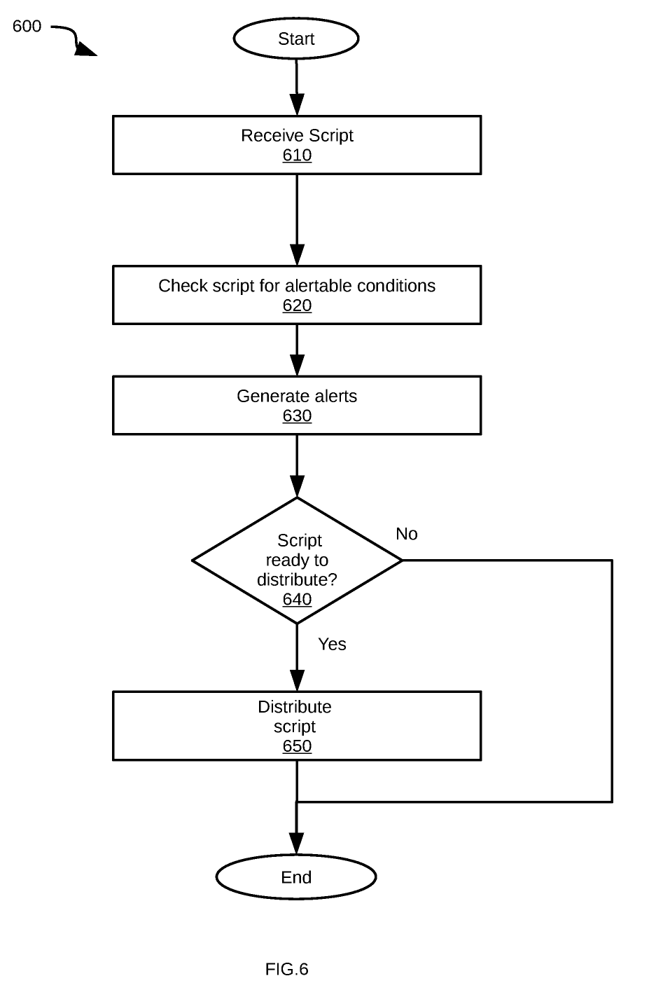

At 550, the action script is generated by reading the permissions from the GATT structure available to the client for the characteristic. The permissions may allow the client to read the value of the characteristic, write a value to the characteristic, or to both read and write. In some cases the client may not have permission to perform any operations for the characteristic and no action will be generated. When the client has read permissions a command may be added to the script to read the value or a register-notify may be generated so that when the script is executed on the client it registers to receive asynchronous notices of updated data. The client may be configured to generate particular command(s) based upon, for example, the type of device, location, administrative preferences regarding commands to be generated, or other factors. When the client has write permissions command(s) may be added to the action script to write a value to the characteristic. In some cases the client may be configured so that the value to be written can be included in the generated script. In other cases, the command added to the action script may be incomplete and an administrator will later edit the script to provide the additional details—in short order, flowchart 600 of FIG. 6 will illustrate an example method whereby an administrator may be alerted to the need for this. The script may be sent to a service, such as monitoring service 230 of FIG. 2, for additional processing or editing at a later time.

Continuing at 560, the client checks to see if there are additional characteristics making up the service. If so the method continues back at 530 to read the next characteristic and continue processing. If not the method advances to 570 where it checks for additional services. If there are additional services the method returns to 510 to read the next service from the GATT structure. If there are no additional services the method ends.

We now turn to flowchart 600 of FIG. 6, illustrating an example method of validating and distributing a script. Starting at 610 the system receives a script. For example, monitoring service 234 of FIG. 2 may accept a simple text file containing a script or a GUI interface may be presented, allowing an administrator to create a script using a higher level interface, without seeing the detailed syntax of the script. For example, human interface manager 234 may provide a GUI interface which device manufacturers can go to create scripts for their devices. Such an interface allows the manufacturer to specify services and characteristics that need to be included, along with operations for each step. The interface may also be beneficial for others, such as application developers, to customize data of interest. In system 200, human interface manager 234 may provide an interface for an administrative user to upload a script and/or an interface to edit a script with a GUI and/or text editor. In addition to these mechanisms to receive a script from a user, system 200 may embody method 500 of FIG. 5, which can be used to generate a script by reading the GATT structure of a Bluetooth LE server. Monitoring service 235 may be configured to generate a preliminary script using a method such as 500, but accept further input from an administrative user to finalize the script before it is deployed. The receiving step 610 of FIG. 6 may be comprised of receiving a generated script.

Continuing at 620, the method checks the received script for conditions that the administrative user should be alerted to. Examples of such conditions include syntax errors in the script and additional information that may be needed to execute the script. At 630 any necessary alerts are generated. For example, a preliminary script may have been generated by method 500 of FIG. 5 that includes a write command because of the permissions available for an attribute. The administrative user is alerted to the existence of this capability and that a value is needs to be specified in the script if the user wants the write operation to be performed. At 640 a decision is made on whether the script is ready to be distributed and used. In some embodiments there may be conditions that alerts are generated for but the script may still be deemed to be ready for distribution. For example, write commands without values to be written might be ignored in some embodiments. Other embodiments may not deem such scripts ready for distribution. If the script is not ready for distribution the method ends, but the method may again be executed against the script at a later time. If, at 640, it's determined that the script is ready the method continues with the distribution of the script at 650. In the example system 200 of FIG. 2, deployment manager 233 sends the script to any BLE server device(s) 201 configured to execute such scripts.

It should be appreciated that the steps illustrated in FIGS. 3-6 provide particular methods according to some example embodiments. Other sequences of steps may also be performed according to alternative example embodiments. For example, alternative embodiments may perform the steps outlined above in a different order. Moreover, the individual steps illustrated in FIGS. 3-6 may include multiple sub-steps that may be performed in various sequences. Furthermore, additional steps may be added or removed depending on the particular application.

It should be appreciated that some embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may be adapted to perform the necessary tasks. The term “computer-readable medium” includes, but is not limited to, portable or fixed storage devices, optical storage devices, wireless channels, sim cards, other smart cards, and various other non-transitory mediums capable of storing, containing, or carrying instructions or data.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based upon” means based at least in part upon. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A method for a Bluetooth LE client to utilize a script to control how it interfaces with a Bluetooth LE server, the method comprising:
the client reading a script comprising instructions to interface with devices of a particular class;
the client waiting for server advertisements;
in response to detecting a server advertisement, the client reading the server advertisement and the client utilizing the server advertisement to make a determination as to whether the script should be executed; and
in response to making said determination the client initiating execution of the script.

2. The method of claim 1, the method further comprising:
the client determining if this is the first time that it has connected to the server; and, in response to determining that this is the first time, executing a preamble section of the script; and
wherein the preamble section of the script is only executed the first time the client connects to the server.

3. The method of claim 1, the method further comprising:
the client reading an action from the script, wherein the script is comprised of an array of actions; and
the client parsing the action to determine a command specified by the action.

4. The method of claim 3, the method further comprising:
the client determining that the command specified is a read command;
the client parsing the command to determine a characteristic that the script is instructing the client to read; and
the client reading the characteristic's data value from the server.

5. The method of claim 4, the method further comprising:
the client parsing the command to determine the type of read the script is instructing the client to conduct; and
responsive to the client determining that the type of read is a measurement type, the client sending the characteristic's data value to the monitoring service.

6. The method of claim 3, the method further comprising:
the client determining that the command specified is a write command;
the client parsing the command to determine a characteristic that the script is instructing the client to write to;
the client parsing the command to determine a value that the script is instructing the client to write into the characteristic; and
the client writing the value into the characteristic on the server.

7. The method of claim 3, the method further comprising:
the client determining that the command specified is a register-notify command;
the client parsing the command to determine a characteristic that the script is instructing the client to enable the characteristic for at least one of notifications and indications; and
the client enabling the characteristic on the server for at least one of notifications and indications.

8. The method of claim 7, the method further comprising:
the client asynchronously waiting for at least one of notifications and indications for the characteristic while continuing on with the execution of the script.

9. The method of claim 3, the method further comprising:
the client determining that the command specified is to be applied to a plurality of characteristics;
the client further parsing the command to determine the plurality of characteristics; and
the client applying the command to the plurality of characteristic on the server.

10. The method of claim 2, the method further comprising:
the client receiving the script from a deployment manager service.

11. A method for a Bluetooth LE client to create a script comprised of instructions for interfacing with a Bluetooth LE server, the method comprising:
the client reading the profile of a Bluetooth LE server, wherein the profile is comprised of one or more services;
for each of the one or more services, the client examining one or more characteristics comprising said service;
the client reading the permissions available for a characteristic; and
the client generating an action step in the script based upon the permissions.

12. The method of claim 11, the method further comprising:
the client receiving instructions from a deployment manager service regarding at least one of a service or a characteristic that should be excluded when generating action items for the script;
wherein the client does not generate action steps when said service is one of the at least one of a service or characteristics that should be excluded when generating action items for the script; and
wherein the client does not generate action steps when the characteristic is one of the at least one of a service or characteristics that should be excluded when generating action items for the script.

13. The method of claim 11, wherein the permissions being to read the characteristic and the action step generated in the script being to read the value of the characteristic.

14. The method of claim 11, wherein the permissions being to write the characteristic and the action step generated in the script being to write to the value of the characteristic.

15. The method of claim 11, the method further comprising:
the client sending the script to a deployment manager service.

16. The method of claim 11, the method further comprising:
wherein no additional internal or external programming is required for at least one of the client or an additional instantiation of the client to utilize the script to interface with at least one of the Bluetooth LE server or an additional instantiation of the Bluetooth LE server.

17. A method for a service to validate and distribute a script comprised of instructions for a Bluetooth LE client to interface with a Bluetooth LE server, the method comprising:
the service receiving a script;
the service checking the script for alertable conditions;
in response to detecting an alertable condition, the service generating an alert;
the service checking the script to determine if it is ready to distribute to Bluetooth LE clients; and
in response to determining that the script is ready, distributing the script to one or more Bluetooth LE clients.

18. The method of claim 17, further comprising:
the service receiving the script from a Bluetooth LE client, wherein the client generated the script by reading the profile of a Bluetooth LE server.

19. The method of claim 18, further comprising:
the service detecting that additional information is required for the action step,
wherein the service generates an alert that additional information is required for the action step.

20. The method of claim 17, further comprising:
the service providing an interface for a user to provide the script;
the service detecting that the script has syntax errors;
the service generating an alert that the script has syntax errors.

21. The method of claim 17, further comprising:
the service providing a GUI for a user to create the script.

22. The method of claim 17, further comprising:
the service receiving data from the one or more Bluetooth LE clients that the script has been distributed to;
wherein the one or more Bluetooth LE clients have collected the data based upon instructions in the script.
